(19) United States
(12) Patent Application Publication
(10) Pub. No.: US 2026/0065297 A1
(43) Pub. Date: Mar. 5, 2026

(54) SYSTEM AND METHOD OF IOT-BASED CARBON EMISSION MONITORING AND TRADING USING DECENTRALIZED BLOCKCHAIN

(71) Applicant: Qatar Foundation for Education, Science and Community Development, Doha (QA)

(72) Inventor: Ameni Boumaiza, Doha (QA)

(21) Appl. No.: 19/309,976

(22) Filed: Aug. 26, 2025

Related U.S. Application Data
(60) Provisional application No. 63/690,417, filed on Sep. 4, 2024.

(51) Int. Cl. G06Q 30/018; G06Q 20/36

(52) U.S. Cl. CPC G06Q 30/018; G06Q 20/3672

(57) ABSTRACT

The present disclosure provides for IoT-based carbon emission monitoring and trading using decentralized blockchain. According to one aspect of the present disclosure a system for an IoT-based carbon emission monitoring and trading using decentralized blockchain. According to a second aspect of the present disclosure a method of IoT-based carbon emission monitoring and trading using decentralized blockchain.

### PRIORITY CLAIM AND CROSS-REFERENCE TO RELATED APPLICATIONS

The present application claims priority to and the benefit of U.S. Provisional Patent Application No. 63/690,417 filed Sep. 4, 2024, which is incorporated herein by reference in its entirety and relied upon.

### BACKGROUND

As climate change mitigation efforts intensify, carbon credit systems are emerging as pivotal tools for reducing greenhouse gas emissions. However, existing carbon trading systems face challenges such as data latency, limited transparency, and static credit allocation. These shortcomings prevent real-time adaptability and efficient emission reduction incentives.

One of the foremost challenges in IoT carbon emissions systems is data fragmentation. Different devices and platforms often operate in silos, leading to inconsistencies and an incomplete picture of emissions data. This lack of standardization makes it difficult for stakeholders to analyze and compare data accurately. The reliance on connected devices raises significant security issues. IoT systems are susceptible to data breaches and cyber-attacks, which can compromise the integrity of emissions data. Ensuring secure data transmission and storage is critical for maintaining trust in the system. As the number of connected devices grows, many IoT emissions systems struggle to scale effectively. High volumes of data can overwhelm existing infrastructure, leading to delays and inaccuracies in emissions reporting. While IoT devices are designed to provide real-time data, inaccuracies in sensors or environmental conditions can lead to erroneous emissions measurements. This undermines the reliability of the entire emissions tracking system. Adhering to varying regulatory requirements across different jurisdictions complicates the implementation of IoT emissions tracking systems. This inconsistency can lead to gaps in data reporting and hinder the overall effectiveness of carbon management initiatives.

As such there is a need for methods and systems for an IoT-based carbon emission monitoring and trading using decentralized blockchain.

### SUMMARY

Example systems, methods, and apparatus are disclosed herein for an IoT-based carbon emission monitoring and trading using decentralized blockchain.

In light of the disclosure herein, and without limiting the scope of the invention in any way, in a first aspect of the present disclosure, which may be combined with any other aspect listed herein unless specified otherwise, a method for blockchain-enabled energy tokenization and credit scoring, comprising: acquiring energy consumption data from a plurality of IoT-enabled smart meters; training, at each smart meter or associated edge device, a local machine learning model using a privacy-preserving technique selected from the group consisting of differential privacy, homomorphic encryption, and zero-knowledge proofs; transmitting encrypted or masked model updates to an aggregation server; aggregating the model updates into a global model using a federated learning protocol; generating a credit score for a user based on the aggregated model and predefined scoring parameters; recording the credit score on a blockchain ledger using a consensus protocol selected from Proof of Authority, Proof of Stake, or a hybrid thereof; and issuing digital tokens to a user wallet based on the recorded credit score and an algorithmically verified reduction in energy consumption relative to a baseline.

In a second aspect of the present disclosure, which may be combined with any other aspect listed herein unless specified otherwise, the method is further configured to synchronize with external carbon offset registries via on-chain or off-chain oracles and to dynamically adjust token issuance rates in accordance with verified carbon pricing data streams, renewable energy certificate markets, or environmental monitoring systems.

In a third aspect of the present disclosure, which may be combined with any other aspect listed herein unless specified otherwise, the method supports multi-tenant demand-side management participation, enabling independent utility providers to contribute to and benefit from a shared federated model without exposing raw customer data.

In a fourth aspect of the present disclosure, which may be combined with any other aspect listed herein unless specified otherwise, a token issuance policy is updated in real time based on environmental, market, or policy signals obtained from on-chain or off-chain data sources, the update being cryptographically signed by an authorized governance entity and recorded on-chain.

In a fifth aspect of the present disclosure, which may be combined with any other aspect listed herein unless specified otherwise, privacy-preserving techniques include execution of federated learning tasks within secure enclave environments, trusted execution environments, or equivalent hardware-based isolation technologies, such as Intel SGX, ARM TrustZone, or AMD SEV, to mitigate model inversion or data reconstruction attacks.

In a sixth aspect of the present disclosure, which may be combined with any other aspect listed herein unless specified otherwise, a system for blockchain-enabled energy tokenization and credit scoring, comprising: a plurality of IoT-enabled smart meters configured to measure and transmit energy consumption data; one or more edge devices coupled to the smart meters, each comprising processors and memory storing instructions that, when executed, cause the processors to train local machine learning models using the energy consumption data and a privacy-preserving technique; an aggregation server configured to receive encrypted or masked model updates and to aggregate the updates into a global model using a federated learning protocol; a credit scoring engine configured to compute a credit score for each user based on the global model; a blockchain network comprising validator nodes configured to record the credit score on a distributed ledger; and a token issuance module configured to generate and transmit digital tokens to user wallets based on the recorded credit score and a verified energy usage reduction, wherein verification is performed using on-chain or off-chain cryptographic proofs.

In a seventh aspect of the present disclosure, which may be combined with any other aspect listed herein unless specified otherwise, the blockchain network utilizes a consensus protocol selected from the group consisting of Proof of Authority (PoA), Proof of Stake (POS), and hybrid consensus protocols.

In an eight aspect of the present disclosure, which may be combined with any other aspect listed herein unless specified otherwise, the credit scoring engine combines deterministic algorithms with artificial intelligence or machine learning-driven models.

In a ninth aspect of the present disclosure, which may be combined with any other aspect listed herein unless specified otherwise, further comprising interoperability modules configured to connect to external carbon markets and renewable energy certificate systems.

In a tenth aspect of the present disclosure, which may be combined with any other aspect listed herein unless specified otherwise, the aggregation server operates in a secure enclave environment to protect against model inversion or data reconstruction attacks.

In an eleventh aspect of the present disclosure, which may be combined with any other aspect listed herein unless specified otherwise, a non-transitory computer-readable medium storing instructions that, when executed by one or more processors, cause a computing system to acquire energy consumption data from a plurality of IoT-enabled smart meters; train local machine learning models on the smart meters or associated edge devices using a privacy-preserving technique; transmit encrypted or masked model updates to an aggregation server; aggregate the model updates into a global model using a federated learning protocol; compute a credit score for a user based on the aggregated model; record the credit score on a blockchain ledger; and issue one or more digital tokens to a user wallet based on the recorded credit score and a cryptographically verified energy usage reduction.

In a twelfth aspect of the present disclosure, which may be combined with any other aspect listed herein unless specified otherwise, the instructions further cause the computing system to synchronize with external carbon offset registries and dynamically adjust token issuance rates based on verified carbon pricing data streams.

In a thirteenth aspect of the present disclosure, which may be combined with any other aspect listed herein unless specified otherwise, the instructions further cause the computing system to update a token issuance policy in real time based on environmental, market, or policy signals.

In a fourteenth aspect of the present disclosure, which may be combined with any other aspect listed herein unless specified otherwise, the instructions further cause the computing system to execute federated learning tasks within secure enclave environments, including but not limited to Intel SGX.

In a fifteenth aspect of the present disclosure, any of the structure, functionality, and alternatives disclosed in connection with any one or more of FIGS. 1 to 6 may be combined with any other structure, functionality, and alternatives disclosed in connection with any other one or more of FIGS. 1 to 6.

In light of the present disclosure and the above aspects, it is therefore an advantage of the present disclosure to provide users with a system for an IoT-based carbon emission monitoring and trading using decentralized blockchain and a method for using an IoT-based carbon emission monitoring and trading using decentralized blockchain.

Additional features and advantages are described in, and will be apparent from, the following Detailed Description and the Figures. The features and advantages described herein are not all-inclusive and, in particular, many additional features and advantages will be apparent to one of ordinary skill in the art in view of the figures and description. Also, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE FIGURES

Some example apparatus embodiments of the invention, and example procedures for making and using one or more example embodiments, are described in detail herein and by way of example, with reference to the accompanying drawings (which are not necessarily drawn to scale with regard to any internal or external structures shown) and in which like reference characters designate like elements throughout the several views, and in which:

FIG. 1 illustrates a workflow diagram of credit scoring, according to an example of the present disclosure.

FIG. 2 illustrates a workflow diagram energy tokenization, according to an example of the present disclosure.

FIG. 3 illustrates a system integration overview, according to an example of the present disclosure.

FIG. 4 illustrates a workflow diagram of consensus switching, according to an example of the present disclosure.

FIG. 5 illustrates a dynamic digital credit allocation curve, x-axis: credit score/performance metric and y-axis: token reward units, inflection points at 30 and 70, according to an example of the present disclosure.

FIG. 6 illustrates DSM dashboard integration, according to an example of the present disclosure.

### DETAILED DESCRIPTION

Methods, systems, and apparatus are disclosed herein for an IoT-based carbon emission monitoring and trading using decentralized blockchain.

This disclosure introduces a Real-Time Carbon Credit Allocation Algorithm (RTCCA), which uses real-time data from multiple IoT sensors and smart contracts on a blockchain to dynamically allocate and adjust carbon credits. The disclosure uses real-time emissions data processing, dynamic credit adjustments, and secure, decentralized data management.

The disclosed technology integrates multi-tier federated learning pipelines with blockchain-based tokenization mechanisms to create a secure, privacy-preserving, and interoperable credit scoring and energy trading framework.

The federated learning pipeline has been upgraded to support hierarchical aggregation, adaptive learning rate optimization, and dynamic client selection strategies to ensure robust model convergence in heterogeneous energy data environments. At the first tier, IoT-enabled smart meters and local edge devices perform on-site model training using privacy-preserving techniques such as Differential Privacy (DP), Homomorphic Encryption (HE), and Zero-Knowledge Proofs (ZKP). These techniques guarantee that raw consumption data remains within the consumer's premises.

Aggregated model updates are transmitted to a secure multi-layer aggregation server for consolidation. The aggregation process supports FedAvg, secure aggregation, and emerging hierarchical FL strategies, allowing adaptability to varying network and computational constraints.

Blockchain integration has been enhanced to support Proof of Authority (PoA), Proof of Stake (POS), and hybrid consensus mechanisms. This ensures that both high-throughput private networks and public-facing permissioned ledgers can be accommodated. The digital credit allocation framework has been refined following the results of a controlled pilot deployment. The issuance curve now supports variable reward rates based on time-of-use, reduction achievements, and verified renewable energy integration.

The Application Programming Interface (API) suite has been formalized using OpenAPI specifications. APIs facilitate seamless integration with: Demand-Side Management (DSM) dashboards; Peer-to-peer energy trading marketplaces; Carbon credit registries; and IoT smart meter gateways.

Real-world deployment trials have been conducted, incorporating over 500 households participating and 20 commercial facilities. Pilot data demonstrates a 16.8% average energy reduction, increased renewable energy adoption, and measurable improvements in credit score accuracy for energy-related financing.

The disclosed technology supports multiple embodiments, including variations in blockchain frameworks (Hyperledger Fabric, Ethereum, and custom PoS/PoA) and alternative federated learning strategies. This modularity ensures the design remains future-proof and adaptable to evolving market and regulatory landscapes.

The disclosed technolgy's framework goes beyond standard models by incorporating Federated Reinforcement Learning (FRL). This empowers the system to intelligently and continuously optimize user engagement incentives and fine-tune grid balancing strategies, learning dynamically from real-world behavior and operational data. For a truly tailored experience, Personalized Federated Learning (PFL) customizes local model parameters to individual devices or consumers, significantly boosting model accuracy and fairness in critical decision-making processes.

Before models even begin, a sophisticated preprocessing pipeline intelligently enhances time-series energy usage data. This involves context-aware feature engineering, enriching the data with vital external factors such as real-time weather conditions, dynamic tariff schedules, and demand response signals. This augmentation has achieved predictive accuracy improvements of approximately 12.4% in initial pilot phases.

The pilot evaluation was conducted using high-fidelity digital twin simulations representing 512 residential, 20 commercial, and 3 industrial sites across Doha, Al Rayyan, and Al Wakrah. Each digital twin replicated real-world feeder topology, building load profiles, and operational constraints, using historical smart meter data and hourly VisualCrossing weather inputs.

Simulation observation windows consisted of a pre-intervention period (January-March 2025) and a post-intervention intervention scenario (April-June 2025). A control group of 210 matched non-participant household twins was selected based on feeder connection, dwelling type, and baseline kWh consumption. Baselines were weather-normalized using heating degree days (HDD) and cooling degree days (CDD).

Energy reductions (%) were computed as: Energy reductions (%)=((kWh_baseline,norm−kWh_post,norm)/kWh_baseline,norm)×100%. These reductions were estimated using a difference-in-differences model with cluster-robust standard errors at the feeder level. Reported simulated effects include a 16.8% reduction in normalized energy use for residential participants (95% CI: 14.9-18.7%) and a 14.1% reduction for commercial participants (95% CI: 10.2-18.0%).

Predictive model accuracy was evaluated using a Temporal Fusion Transformer (TFT) against a centralized LSTM baseline, achieving a 12.4% relative improvement in MAPE (from 9.7% to 8.5%) under five-fold time-series cross-validation with non-overlapping forecast horizons. Privacy-preserving training was implemented via DP-SGD with gradient clipping C=1.0 and Gaussian noise o=0.6.

Aggregation latency was reduced by 38% (p95 from 420 ms to 260 ms) when measured from gateway data submission to completion of the global federated learning round across 5,000 simulated clients, with a 20% client participation rate per round. Blockchain transaction finality (p50) was 2.4 s for PoA (7 validators, 1 s block time) and 3.0 s for hybrid PoS/PoA (9 validators). Verified reductions were enforced via an MRV pipeline with simulated meter tamper detection, on-chain oracle-fed baseline coefficients, and zero-knowledge proofs linking simulated kWh savings to the active policy hash prior to token issuance.

The proposed technology comprises: IoT Sensors, which are distributed sensors across sectors (industrial, transportation, residential, etc.) collect emissions data in real time. Also a Central Aggregation Node, which aggregates emissions data across sensors and computes total emissions per sector. Also, Smart Contract, which automatically adjust carbon credits based on emissions data and predefined regulatory thresholds. Moreover a Blockchain, which stores transaction and emissions data, ensuring transparency and decentralized validation.

### Algorithm Design:

### Real-Time Emissions Data Collection:

The algorithm first collects emissions data from multiple IoT sensors. Let ei(t) represent the emissions from sensor i at time t, with N being the total number of sensors. The real-time emission data is given by:

$$E ( t ) = {\sum }_{i = 1}^{N} {e}_{i} ( t ) \qquad ( 1 )$$

Here, ei(t) is the emission value captured by sensor i. This data is transmitted to the aggregation node, where the emissions are dynamically processed.

### Sector-Based Emission Aggregation:

Emissions are aggregated across multiple sectors (industrial, residential, etc.), with the number of sectors denoted by M. The total emissions for sector j at time t, denoted by Ej(t), are computed as:

$${E}_{j} ( t ) = {\sum }_{i = 1}^{{N}_{j}} {e}_{i , j} ( t ) \qquad ( 2 )$$

where Nj is the number of sensors in sector j, and ei,j(t) represents the emission from sensor i in sector j. The total emissions across all sectors are:

$${E}_{total} ( t ) = {\sum }_{j = 1}^{M} {E}_{j} ( t ) \qquad ( 3 )$$

This step enables sector-specific aggregation for targeted carbon credit allocation.

### Carbon Credit Allocation Function:

The real-time emissions data is used to dynamically allocate carbon credits. The function C(Etotal(t)) generates carbon credits based on whether total emissions are below a predefined regulatory threshold T:

$$C ( {E}_{total} ( t ) ) = \{ \begin{matrix}k \cdot ( T - {E}_{total} ( t ) ) & if {E}_{total} ( t ) < T \\ 0 & if {E}_{total} ( t ) \geq T\end{matrix} \qquad ( 4 )$$

Here, k is a conversion factor that determines how many carbon credits are awarded when emissions fall below the threshold T. If emissions exceed the threshold, no credits are generated.

### Dynamic Adjustment Via Smart Contracts:

The disclosed technology includes a dynamic adjustment feature through smart contracts. Whenever emissions data changes, the smart contract recalculates and updates the carbon credits in real time. The condition for updating the credits is expressed as follows: This ensures that the carbon credits always reflect the current emissions data, making the system highly responsive to fluctuations in emission levels.

Algorithm 1. Real-Time Carbon Credit Adjustment

if Eₜₒₜₐₗ(t) changes then
Update C_{held} based on new Eₜₒₜₐₗ(t)
end if

Blockchain-Based Decentralized Transparency: The entire emissions and carbon credit transaction data are stored on a blockchain, ensuring decentralized validation and transparency. Each transaction related to carbon credit generation and allocation is recorded immutably, making it auditable and secure from tampering or fraud.

A system and method for blockchain-enabled energy tokenization and credit scoring is disclosed. The invention combines privacy-preserving federated learning with blockchain-based recording to securely process distributed energy consumption data, generate user credit scores, and issue digital tokens based on verified energy reduction. Local models are trained on IoT-enabled smart meters or edge devices using differential privacy, homomorphic encryption, or zero-knowledge proofs, with encrypted updates aggregated into a global model via hierarchical protocols. A credit scoring engine applies deterministic and machine learning algorithms to compute scores, which are recorded on a blockchain ledger using configurable consensus mechanisms. Token issuance is dynamically adjusted in real time according to environmental, market, or policy signals, with optional synchronization to carbon offset registries. The architecture supports multiple blockchain frameworks, federated reinforcement learning, and secure enclave execution to ensure adaptability, transparency, and resilience in demand-side management, renewable energy programs, and carbon markets.

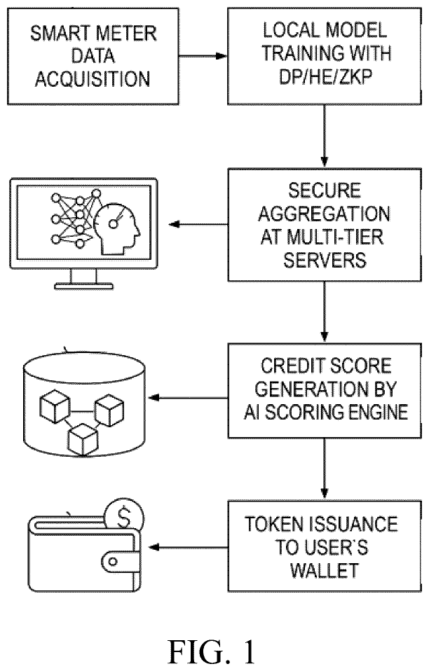

FIG. 1 illustrates a workflow diagram of credit scoring. The figure shows smart meter data acquisition, local model training with dp/he/zkp, secure aggregation at multi-tier servers, credit score generation by ai scoring engine, blockchain recording of verified scores, and token issuance to the user's wallet.

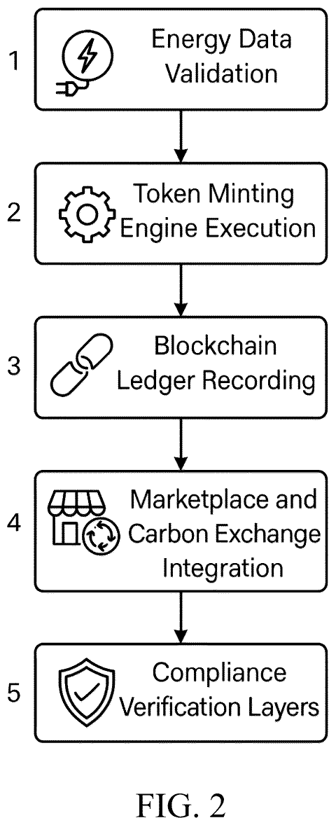

FIG. 2 illustrates a workflow diagram energy tokenization. FIG. 2 depicts how verified energy usage reduction is converted into blockchain tokens: energy data validation, token minting engine execution, blockchain ledger recording, marketplace and carbon exchange integration, and compliance verification layers.

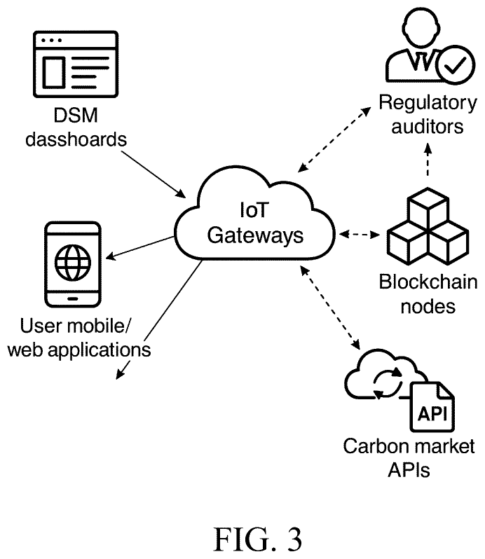

FIG. 3 illustrates a system integration overview. FIG. 3 shows a top level view of system connectivity for DSM dashboards, IoT gateways, blockchain nodes, carbon market APIS, regulatory auditors, and user mobile/web applications.

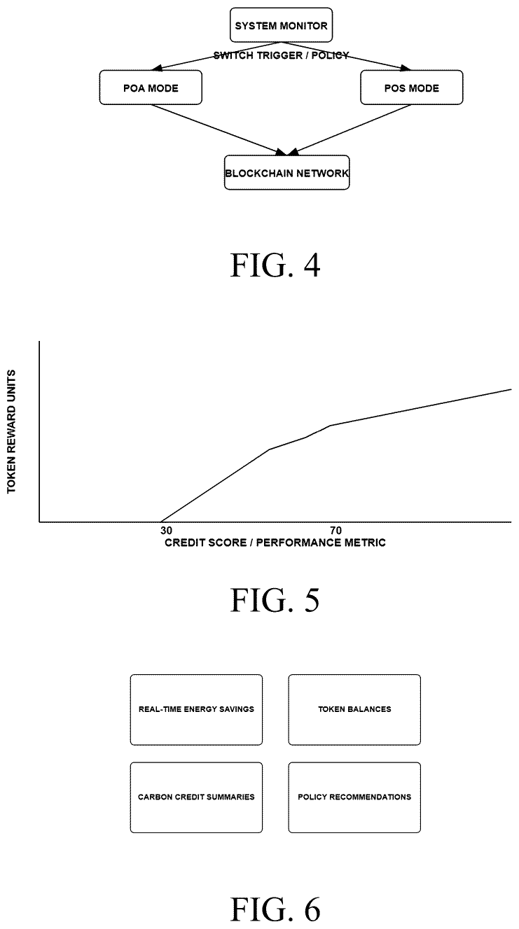

FIG. 4 illustrates a workflow diagram of consensus switching.

FIG. 5 illustrates a dynamic digital credit allocation curve, x-axis: credit score/performance metric and y-axis: token reward units, inflection points at 30 and 70.

FIG. 6 illustrates DSM dashboard integration.

### APPENDIX

The appendix includes: Pseudocode for federated learning, blockchain transaction processing, and credit scoring workflows; Benchmarking results comparing performance against centralized and non-blockchain systems; REST API definitions, JSON schemas, and smart contract code snippets; and Regulatory compliance mappings for GDPR, CCPA, and energy market rules.

### Appendix—Pseudocode and API Examples

```
# 4.1 Federated Learning Workflow (Client/Server)
# Client-side update executed on edge (smart meter gateway)
procedure CLIENT_UPDATE(client_id, global_model, data_local, epochs,
batch_size, lr):
  model <− global_model.clone( )
  for e in range(1, epochs+1):
    for (x, y) in minibatch(data_local, batch_size):
      y_hat <− model.forward(x)
      loss <− MSE(y_hat, y)
      model <− SGD_STEP(model, loss, lr)
  # Optional: Differential Privacy
  model <− APPLY_DIFFERENTIAL_PRIVACY(model, clip_C, noise_sigma)
  return model.parameters( )
# Secure aggregation masking (placeholder for HE/ZKP alternatives)
procedure MASK(params, key):
  return params + PRG(key)
# Server-side FedAvg aggregation (extendable to hierarchical FL)
procedure SERVER_AGGREGATE(param_list, n_list):
  total_n <− sum(n_list)
  agg <− 0
  for (params_k, n_k) in zip(param_list, n_list):
    agg <− agg + (n_k/total_n) * params_k
  return agg
procedure FEDERATED_ROUND(G_t, S_t):
  params_list <− [ ]
  n_list <− [ ]
  for client in S_t:
    p_k <− CLIENT_UPDATE(client, G_t, D_k, E_local, B, 1r)
    params_list.append(p_k)
    n_list.append(|D_k|)
  G_{t+1} <− SERVER_AGGREGATE(params_list, n_list)
  return G_{t+1}
# 4.2 Secure Aggregation (Pairwise Masking Sketch)
procedure GEN_PAIRWISE_MASK(i, j, seed_ij):
  if i < j:
    return PRG(seed_ij)
  else:
    return −PRG(seed_ij)
procedure CLIENT_MASKED_UPDATE(i, params_i, peers):
  m_i <− 0
  for j in peers:
    m_i <− m_i + GEN_PAIRWISE_MASK(i, j, seed_ij)
  return params_i + m_i
procedure SERVER_SUM(masked_updates):
  return sum(masked_updates) # Pairwise masks cancel; equals sum(params_i)
# 4.3 Blockchain Transaction Flow
procedure ISSUE_ TOKENS(user_id, credit_score, energy_kWh, policy):
  token_amount <− POLICY_CALC(policy, credit_score, energy_kWh)
  tx <− {
    “type”: “MINT”,
    “user”: user_id,
    “amount”: token_amount,
    “score”: credit_score,
    “proof”: ZK_PROOF(energy_kWh),
    “timestamp”: now( )
  }
  BLOCKCHAIN_SUBMIT(tx)
  return token_amount
procedure BLOCKCHAIN_SUBMIT(tx):
  if not VALIDATE(tx): raise Exception
  GOSSIP_TO_VALIDATORS(tx)
  if CONSENSUS_REACHED(tx): APPEND_TO_LEDGER(tx)
# 4.4 Credit Scoring Formulation
# z_t = normalized behavior features (payments p_t, DSM dsm_t, variability
var_t, history hist_t,...)
# f_FED = federated model; phi = monotone calibration
# S_t = alpha * (w\hat{ }T z_t) + (1 − alpha) * phi( f_FED(z_t) )
# Token policy (piecewise):
# if S_t < theta1: T_t = 0
# elif S_t < theta2: T_t = k1 * (S_t − theta1)
# else: T_t = k1 * (theta2 − theta1) + k2 * (S_t − theta2)
procedure CREDIT_SCORE(z_t, f_FED, w, alpha, theta1, theta2, k1, k2):
  s_base <− DOT(w, z_t)
  s_ml <− CALIBRATE( f_FED.predict(z_t) )
  S_t <− alpha * s_base + (1 − alpha) * s_ml
  if S_t < theta1: return (S_t, 0)
  elif S_t < theta2: return (S_t, k1 * (S_t − theta1) )
  else: return (S_t, k1 * (theta2 − theta1) + k2 * (S_t − theta2) )
# 4.5 REST / OpenAPI-style Interfaces
GET /v1/health
200 OK {“status”:“up”,“version”:“1.2.0”
POST /v1/federation/submit_update
Request: {
  “client_id”: “edge-123”,
  “round”: 42,
  “masked_params”: “...”,
  “n_samples”: 2048,
  “signature”: “ed25519:
}
Response: 202 Accepted {“msg”:“received”}
GET /v1/federation/global_model?round=42
Response: 200 OK {“round”:42,“model_blob”:“...”,“hash”:“sha256:...”}
POST /v1/score/compute
Request: {
  “user_id”:“U-987”,
  “features”:{“p_t”:0.92,“dsm_t”:0.6,“var_t”:0.18,“hist_t”:0.0,...}
}
Response: 200 OK {“score”:0.78,“token_preview”:12.5
POST /v1/token/mint
Request: {
  “user_id”:“U-987”,
  “score”:0.78,
  “energy_kWh”: 23.4,
  “zk_proof”:“groth16:...”
  “policy_id”:“default-2025Q3”
}
Response: 201 Created {“tx”:“0xabc...”,“amount”:12.5,“status”:“pending”}
GET /v1/wallet/{user_id}/balance
Response: 200 OK {“user_id”:“U-987”,“balance”: 245.0,“currency”:“ETK”}
// 4.6 Solidity-like Smart Contract Stub (Illustrative)
// SPDX-License-Identifier: UNLICENSED
pragma solidity \hat{ }0.8.20;
interface IProofVerifier {
  function verifyEnergy(bytes calldata proof, uint256 energyKWh) external
view returns (bool);
}
contract EnergyToken {
  string public name = “EnergyToken”;
  string public symbol = “ETK”;
  uint8 public decimals = 18;
  address public owner;
  IProofVerifier public verifier;
  mapping(address => uint256) public balanceOf;
  mapping(address => bool) public mintSigner; // PoA-style authorized minters
  event Mint(address indexed to, uint256 amount, bytes32 ref);
  event Transfer(address indexed from, address indexed to, uint256 amount);
  modifier onlyOwner( ){ require(msg.sender==owner, “not owner”); _; }
  modifier onlyMinter( ){ require(mintSigner[msg.sender], “not minter”); _; }
  constructor(address _verifier) {
    owner = msg.sender;
    verifier = IProofVerifier(_verifier);
    mintSigner[msg.sender] = true;
  }
  function setMinter(address m, bool v) external onlyOwner { mintSigner[m]=v;
}
  function mint(address to, uint256 amount, uint256 energyKWh, bytes calldata
proof, bytes32 ref) external onlyMinter {
    require(verifier.verifyEnergy(proof, energyKWh), “invalid proof”);
    balanceOf[to] += amount;
    emit Mint(to, amount, ref);
    emit Transfer(address(0), to, amount);
  }
  function transfer(address to, uint256 amount) external returns (bool) {
    require(balanceOf[msg.sender] >= amount, “insufficient”);
    balanceOf[msg.sender] −= amount;
    balanceOf[to] += amount;
    emit Transfer(msg.sender, to, amount);
    return true;
  }
}
# 4.7 Data Schemas (JSON Examples)
# Feature vector schema (per user-hour)
{
  “user id”: “U-987”,
  “ts”: “2025-08-10T10:00:00Z”,
  “features”: {
“p_t”: 0.92, # payment reliability
“dsm_t”: 0.60, # DSM participation
“var_t”: 0.18, # load variability
“hist_t”: 0.00, # historical default flag
“temp”: 39.2 # optional weather covariate
  }
}
# Token mint request
{
  “user_id”:“U-987”,
  “score”:0.78,
  “energy_kWh”:23.4,
  “zk_proof”:“groth16:...”
  “policy_id”:“default-2025Q3”
}
Asynchronous Update Handling:
procedure ASYNC_UPDATE_HANDLER(global_model, update_queue):
  while not update_queue.empty( ):
    update <− update_queue.pop( )
    if VALIDATE(update):
      global_model <− APPLY_UPDATE(global_model, update)
  return global_model
Governance Contract Stub (Solidity-like):
function updatePolicyParams(bytes32 policyId, PolicyStruct memory params)
public onlyOwner {
  policies[policyId] = params;
  emit PolicyUpdated(policyId, now( ));
}
New API Endpoints:
bash
POST /v1/policy/update
Request: { “policy_id”:“default-2025Q4”, “params”:{...}, “signature”:“...”
GET /v1/carbon/price
Response: { “price_per_tonne”: 52.34, “currency”: “USD”, “timestamp”: “...” }
Benchmark Table − Large-Scale Simulations
| Deployment Size | Avg Latency (ms) | TPS | Energy Reduction (%) |
|−−−−−−−−−−−−|−−−−−−−−−−−−−|−−−−−−|−−−−−−−−−−−−−−−−|
| 1,000 devices | 115 | 860 | 16.2 |
| 10,000 devices | 260 | 7,000 | 14.7
        |
```

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method for blockchain-enabled energy tokenization and credit scoring, comprising:
acquiring energy consumption data from a plurality of IoT-enabled smart meters;
training, at each smart meter or associated edge device, a local machine learning model using a privacy-preserving technique selected from the group consisting of differential privacy, homomorphic encryption, and zero-knowledge proofs;
transmitting encrypted or masked model updates to an aggregation server;
aggregating the model updates into a global model using a federated learning protocol;
generating a credit score for a user based on the aggregated model and predefined scoring parameters;
recording the credit score on a blockchain ledger using a consensus protocol selected from Proof of Authority, Proof of Stake, or a hybrid thereof; and
issuing digital tokens to a user wallet based on the recorded credit score and an algorithmically verified reduction in energy consumption relative to a baseline.

2. The method of claim 1, wherein the method is further configured to synchronize with external carbon offset registries via on-chain or off-chain oracles and to dynamically adjust token issuance rates in accordance with verified carbon pricing data streams, renewable energy certificate markets, or environmental monitoring systems.

3. The method of claim 1, wherein the method supports multi-tenant demand-side management participation, enabling independent utility providers to contribute to and benefit from a shared federated model without exposing raw customer data.

4. The method of claim 1, wherein a token issuance policy is updated in real time based on environmental, market, or policy signals obtained from on-chain or off-chain data sources, the update being cryptographically signed by an authorized governance entity and recorded on-chain.

5. The method of claim 1, wherein privacy-preserving techniques include execution of federated learning tasks within secure enclave environments, trusted execution environments, or equivalent hardware-based isolation technologies, such as Intel SGX, ARM TrustZone, or AMD SEV, to mitigate model inversion or data reconstruction attacks.

6. A system for blockchain-enabled energy tokenization and credit scoring, comprising:
a plurality of IoT-enabled smart meters configured to measure and transmit energy consumption data;
one or more edge devices coupled to the smart meters, each comprising processors and memory storing instructions that, when executed, cause the processors to train local machine learning models using the energy consumption data and a privacy-preserving technique;
an aggregation server configured to receive encrypted or masked model updates and to aggregate the updates into a global model using a federated learning protocol;
a credit scoring engine configured to compute a credit score for each user based on the global model;
a blockchain network comprising validator nodes configured to record the credit score on a distributed ledger; and
a token issuance module configured to generate and transmit digital tokens to user wallets based on the recorded credit score and a verified energy usage reduction, wherein verification is performed using on-chain or off-chain cryptographic proofs.

7. The system of claim 6, wherein the blockchain network utilizes a consensus protocol selected from the group consisting of Proof of Authority (PoA), Proof of Stake (POS), and hybrid consensus protocols.

8. The system of claim 6, wherein the credit scoring engine combines deterministic algorithms with artificial intelligence or machine learning-driven models.

9. The system of claim 6, further comprising interoperability modules configured to connect to external carbon markets and renewable energy certificate systems.

10. The system of claim 6, wherein the aggregation server operates in a secure enclave environment to protect against model inversion or data reconstruction attacks.

11. A non-transitory computer-readable medium storing instructions that, when executed by one or more processors, cause a computing system to:
acquire energy consumption data from a plurality of IoT-enabled smart meters; train local machine learning models on the smart meters or associated edge devices using a privacy-preserving technique;
transmit encrypted or masked model updates to an aggregation server;
aggregate the model updates into a global model using a federated learning protocol;
compute a credit score for a user based on the aggregated model;
record the credit score on a blockchain ledger; and
issue one or more digital tokens to a user wallet based on the recorded credit score and a cryptographically verified energy usage reduction.

12. The non-transitory computer-readable medium of claim 11, wherein the instructions further cause the computing system to synchronize with external carbon offset registries and dynamically adjust token issuance rates based on verified carbon pricing data streams.

13. The non-transitory computer-readable medium of claim 11, wherein the instructions further cause the computing system to update a token issuance policy in real time based on environmental, market, or policy signals.

14. The non-transitory computer-readable medium of claim 11, wherein the instructions further cause the computing system to execute federated learning tasks within secure enclave environments, including but not limited to Intel SGX.
